(19) United States
(12) Patent Application Publication
(10) Pub. No.: US 2025/0318657 A1
(43) Pub. Date: Oct. 16, 2025

(54) MULTI-ZONE ADJUSTABLE FIRMNESS MATTRESS AND METHOD

(71) Applicant: Dennis Boyd, Chesterfield, MO (US)

(72) Inventor: Dennis Boyd, Chesterfield, MO (US)

(21) Appl. No.: 19/040,218

(22) Filed: Jan. 29, 2025

Related U.S. Application Data
(60) Provisional application No. 63/626,796, filed on Jan. 30, 2024.

(51) Int. Cl. A47C 27/00; A47C 27/08; A47C 27/10; A47C 27/14; A47C 27/15; A47C 27/16; B32B 5/18; B32B 5/32; B32B 7/022

(52) U.S. Cl. CPC A47C 27/001; A47C 27/082; A47C 27/10; A47C 27/148; A47C 27/15; A47C 27/16; B32B 5/18; B32B 5/32; B32B 7/022; B32B 2479/00

(57) ABSTRACT

An adjustable mattress assembly including a support tray, an inflatable air chamber, a support block, and upper pad is provided. The inflatable air chamber is removably disposed in the support tray. The support block is removably and reorientably disposed in the support tray. The support block includes a first layer formed of a first foam and a second layer bonded to the first layer. The second layer is formed of a second foam. The first foam is firmer than the second foam. The upper pad removably overlays the support tray, the inflatable air chamber, and the support block.

### CROSS-REFERENCE

This application claims priority to U.S. Provisional Application No. 63/626,796 filed Jan. 30, 2024, the entire disclosure of which is incorporated herein by reference.

### BACKGROUND

In recent years, a wide variety of customizable mattresses with aims to improve user comfort have become available. Many of these mattresses employ mechanical, hydraulic, or fluid systems to provide customization. Other customizable mattresses employ interchangeable components to provide customization.

While conventional customizable mattresses provide many benefits, they are also subject to various drawbacks. Some conventional customizable mattresses are elaborate and complicated. Other conventional customizable require electric power. Yet other conventional customizable require a stock of interchangeable parts. This proliferation of complexity may increase maintenance costs to keep the customizable mattresses in good working order, increase the production cost of the customizable mattresses, and/or frustrate users. Accordingly, more sophisticated, robust, and simplified customizable mattresses would be useful.

### SUMMARY

Some embodiments provide an adjustable mattress assembly including a support tray, an inflatable air chamber, a support block, and an upper pad. Th inflatable air chamber is removably disposed in the support tray. The support block is removably and reorientably disposed in the support tray. The support block includes a first layer formed of a first foam and a second layer bonded to the first layer. The second layer is formed of a second foam. The first foam is firmer than the second foam. The upper pad removably overlays the support tray, the inflatable air chamber, and the support block.

In some embodiments, the support block is flippable to selectively face the first layer or the second layer upwardly.

In some embodiments, the inflatable air chamber is configured to be selectively inflated and deflated.

In some embodiments, the support tray is formed of a third foam and the upper pad is formed of a fourth foam.

In some embodiments, the support block is a first support block, and the adjustable mattress also includes a second support block, the second support block being identical to the first support block, the inflatable air chamber being between the first support block and the second support block, and the upper pad removably overlaying the second support block.

In some embodiments, the inflatable air chamber and the support block fit together snugly to substantially prevent movement of the inflatable air chamber and the support block relative to one another.

In some embodiments, the inflatable air chamber fits in the support tray snugly to substantially prevent movement of the inflatable air chamber relative to the support tray.

In some embodiments, the support block fits in the support tray snugly to substantially prevent movement of the support block relative to the support tray.

In some embodiments, the adjustable mattress assembly also includes an upper cover removably attached to lower cover, the upper cover and the lower cover enveloping the support tray and the upper pad.

In some embodiments, the adjustable mattress assembly of claim 1, also includes a slipcover enveloping the upper pad and secured to the support tray.

Some embodiments provide a variable firmness sleep system that includes a remote control, a pump, and an adjustable mattress assembly. The pump is in communication with the remote control. The adjustable mattress assembly is connected to the pump. The adjustable mattress assembly includes a support tray, an inflatable air chamber, and a support block. The inflatable air chamber is removably disposed in the support tray and in fluid communication with the pump. The support block is removably and reorientably disposed in the support tray. The support block includes a first layer formed of a first foam and a second layer bonded to the first layer. The second layer is formed of a second foam. The first foam is firmer than the second foam.

In some embodiments, the remote control selectively instructs the pump to adjust an internal air pressure of the inflatable air chamber.

In some embodiments, the pump selectively inflates and deflates the inflatable air chamber.

In some embodiments, the pump adjusts the internal air pressure of the inflatable air chamber to a predetermined value.

In some embodiments, the inflatable air chamber and the support block are disposed within the support tray.

In some embodiments, the support tray defines a passage, the inflatable air chamber is connected to the pump via tubing, and the tubing extends through the passage.

In some embodiments, the support block is a first support block, and the variable firmness sleep system also includes a second support block, the inflatable air chamber being between the first support block and the second support block.

In some embodiments, the inflatable air chamber is a first inflatable air chamber, and the variable firmness sleep system also includes a second inflatable air chamber in fluid communication with the pump, the first inflatable air chamber abutting the second inflatable air chamber.

In some embodiments, the remote control selectively instructs the pump to toggle between the first inflatable air chamber and the second inflatable air chamber.

Some embodiments provide a method for customizing an adjustable mattress including removing an upper cover of the adjustable mattress from a lower cover of the adjustable mattress; removing an upper pad of the adjustable mattress from a base of the adjustable mattress; orienting one or more support blocks of the base, each of the one or more support blocks including a first layer formed of a first foam, and a second layer bonded to the first layer, the second layer being formed of a second foam, the first foam being firmer than the second foam; returning the upper pad to the base; reattaching the upper cover to the lower cover; and adjusting, with a pump, internal pressures of one or more inflatable air chambers of the base.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is an isometric drawing of a first variable firmness sleep system, according to the principles of this disclosure;

FIG. 2 is an exploded view of the first variable firmness sleep system of FIG. 1;

FIG. 3 is an isometric view of a pump and a cushion assembly of the first variable firmness sleep system of FIG. 1;

FIG. 4 is a top view of the pump and a base of the cushion assembly of FIG. 3;

FIG. 5 is an isometric view of a support tray of the base of FIG. 4;

FIG. 6 is an isometric view of a support block of the base of FIG. 4;

FIG. 7 is an isometric view of a first air chamber and a second air chamber of the base of FIG. 4;

FIG. 8 illustrates a side view of a user resting on the first variable firmness sleep system of FIG. 1 and an enlarged view of a remote control of the first variable firmness sleep system of FIG. 3, according to the principles of this disclosure;

FIG. 9 is a schematic view of the first variable firmness sleep system of FIG. 1 disassembled and packed in a shipping box, according to the principles of this disclosure;

FIG. 10 is a flow diagram depicting a first method for operating at least one device within the first variable firmness sleep system of FIG. 1 according to the principles of this disclosure;

FIG. 11 is an isometric drawing of a second variable firmness sleep system, according to the principles of this disclosure; and

FIG. 12 is a flow diagram depicting a second method for operating at least one device within the second variable firmness sleep system of FIG. 11 according to the principles of this disclosure.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein are for the purpose of description and should not be regarded as limiting. For example, the use of “including,” “comprising,” or “having” and variations thereof herein is meant to encompass the items listed thereafter and equivalents thereof as well as additional items.

As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

As used herein, unless otherwise specified or limited, “at least one of A, B, and C,” and similar other phrases, are meant to indicate A, or B, or C, or any combination of A, B, and/or C. As such, this phrase, and similar other phrases can include single or multiple instances of A, B, and/or C, and, in the case that any of A, B, and/or C indicates a category of elements, single or multiple instances of any of the elements of the categories A, B, and/or C.

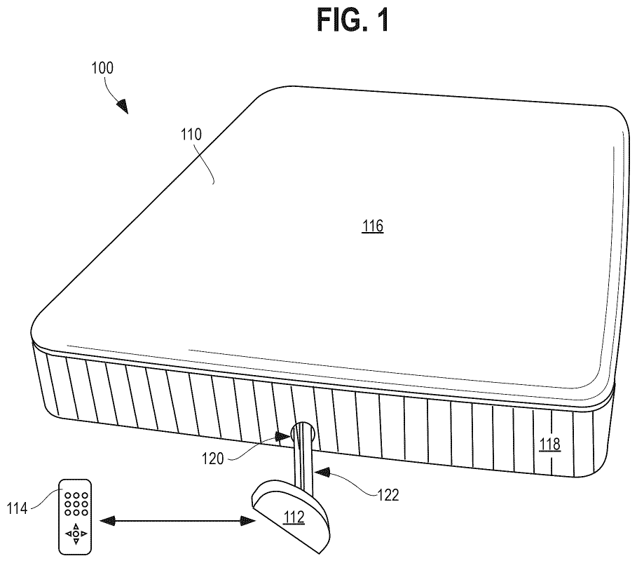

As explained above, it would be useful to provide a more sophisticated, robust, and simplified customizable mattress. More particularly, a customizable mattress that has self-contained reconfigurable components and adjusts to suit the comfort of a user. FIG. 1 illustrates a first variable firmness sleep system 100 according to one embodiment. The first variable firmness sleep system 100 includes an adjustable mattress 110, a pump 112, and a remote control 114. The adjustable mattress 110 includes an upper cover 116 and a lower cover 118, which defines a first opening 120. The upper cover 116 and the lower cover 118 are removably connected together (e.g., zipped, buttoned, snapped, etc.). The upper cover 116 and the lower cover 118 are washable.

Referring again to FIG. 1, the pump 112 is connected to the adjustable mattress 110 by tubing 122, which passes through the first opening 120 into an interior of the adjustable mattress 110. The pump 112 inflates and deflates portions of the adjustable mattress 110 via the tubing 122, as will be explained in greater detail below. In some embodiments, the pump 112 is powered by an external electrical outlet (not shown). In some embodiments, the pump 112 is battery powered. The pump 112 is in communication with the remote control 114. In some embodiments, the pump 112 communicates with the remote control 114 via a wired connection. In some embodiments, the pump 112 communicates with the remote control 114 wirelessly.

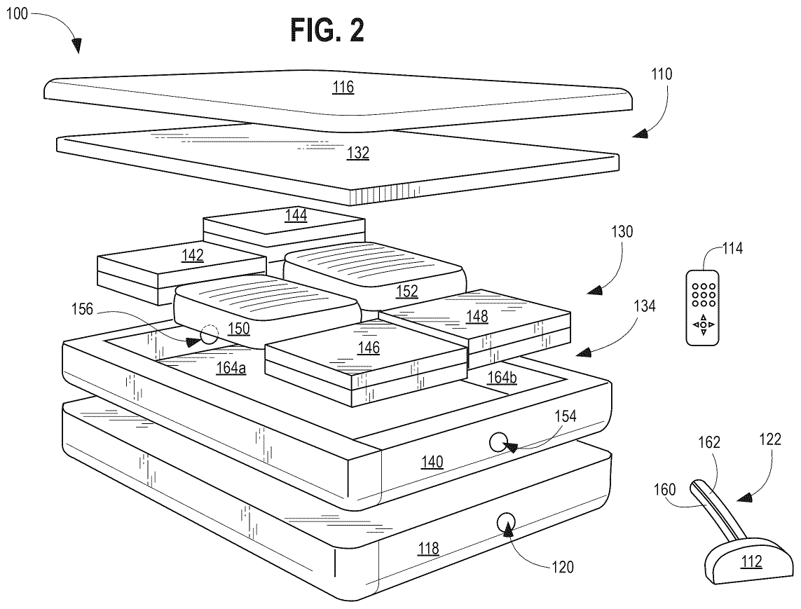

Referring to FIG. 2, the adjustable mattress 110 further includes a cushion assembly 130. When the adjustable mattress 110 is assembled, the cushion assembly 130 is enveloped by the upper cover 116 and the lower cover 118. The cushion assembly 130 includes an upper pad 132 and a base 134. In some embodiments, the upper pad 132 is formed of elastomeric foam. In some embodiments, the upper pad 132 is formed of a plurality of layers of elastomeric foam of varying densities (e.g., firmness) laminated together. In some embodiments, the upper pad 132 is perforated to facilitate enhanced airflow.

Remaining with FIG. 2, the base 134 includes a support tray 140, a first support block 142, a second support block 144, a third support block 146, and a fourth support block 148, which may be substantially identical to one another in some embodiments. In some embodiments, the first support block 142, the second support block 144, the third support block 146, and the fourth support block 148 are perforated to facilitate enhanced air flow throughout the base. The base 134 additionally includes a first inflatable air chamber 150 and a second inflatable air chamber 152, which may be substantially mirror images of one another in some embodiments. The support tray 140 defines a first passage 154 and a second passage 156. In some embodiments, the support tray 140 is formed of elastomeric foam. The lower cover 118 further defines a second opening (not shown). When the adjustable mattress 110 is assembled, the first passage 154 and the second passage 156 respectively align with the first opening 120 and the second opening. The tubing 122 includes a first tube 160 and a second tube 162. In some instances, the cushion assembly 130 further includes one or more massage motors 164a, b disposed in the base 134. In some instances, the massage motors 164a, b are contained within the support tray 140 and located under the support blocks 142, 144, 146, 148 and/or the inflatable air chambers 150, 152. The remote control 114 communicates with and controls the massage motors 164a, b via a wired and/or wireless connection. Further, in some instances, the remote control 114 is equipped with a child lock feature (e.g., simultaneously pressing a combination of buttons) to prevent children from operating the adjustable mattress 110.

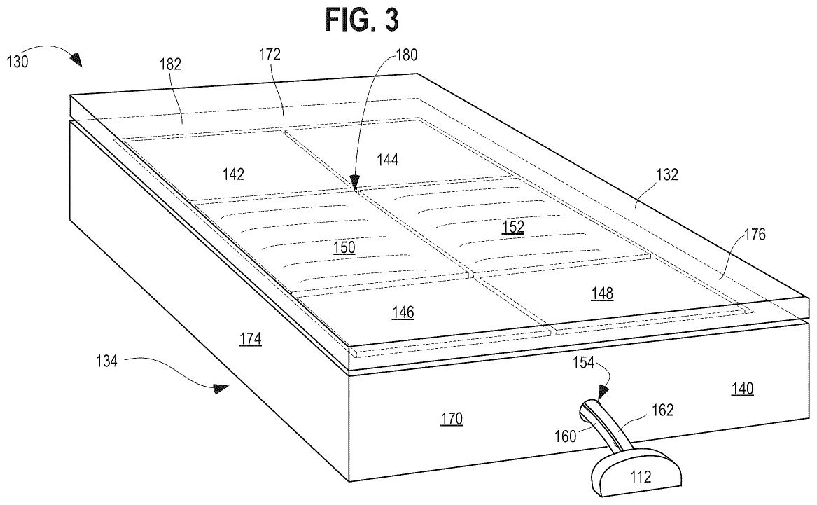

Turning to FIG. 3, the support tray 140 has a first sidewall 170, a second sidewall 172, a third sidewall 174, a fourth sidewall 176, which are connected to a bottom wall 178 to define a cavity 180. The first sidewall 170 and the second sidewall 172 are each connected to the third sidewall 174 and to the fourth sidewall 176. The first sidewall 170 defines the first passage 154, through which the tubing 122 extends into the cavity 180.

Remaining with FIG. 3, the support tray 140 supports and contains the first support block 142, the second support block 144, the third support block 146, the fourth support block 148, the first inflatable air chamber 150, and the second inflatable air chamber 152, which may together substantially fill the cavity 180 from the bottom wall 178 to an upper surface 182 of the support tray 140 and may be selectively removed from the cavity 180. The first support block 142, the second support block 144, the third support block 146, the fourth support block 148, the first inflatable air chamber 150, and the second inflatable air chamber 152 fit together and within the support tray 140 snugly. Thus, the first support block 142, the second support block 144, the third support block 146, the fourth support block 148, the first inflatable air chamber 150, and the second inflatable air chamber 152 are substantially prevented from moving relative to one another and the support tray 140.

Looking again at FIG. 3, more specifically, the first inflatable air chamber 150 is between the first support block 142 and the third support block 146. The second inflatable air chamber 152 is between the second support block 144 and the fourth support block 148. The first support block 142 abuts the second sidewall 172 and the third sidewall 174. The second support block 144 abuts the second sidewall 172 and the fourth sidewall 176. The third support block 146 abuts the first sidewall 170 and the third sidewall 174. The fourth support block 148 abuts the first sidewall 170 and the fourth sidewall 176. As noted below, these relative positions of the first support block 142, second support block 144, third support block 146, fourth support block 148, first inflatable air chamber 150, and second inflatable air chamber 152 may be selectively changed based on a user's preferences.

Referring further to FIG. 3, the upper pad 132 (shown in phantom) removably overlays the support tray 140, the first support block 142, the second support block 144, the third support block 146, the fourth support block 148, the first inflatable air chamber 150, and the second inflatable air chamber 152.

Remaining with FIG. 3, in operation, the pump 112 adjusts air pressure within (e.g., inflates and deflates) the first inflatable air chamber 150 via the first tube 160 to suit a user's comfort. Similarly, in operation, the pump 112 adjusts air pressure within the second inflatable air chamber 152 via the second tube 162. It should be understood and appreciated that the first support block 142, the second support block 144, the third support block 146, and the fourth support block 148 may be removed, reoriented (e.g., reversed, turned over, flipped, etc.), rearranged, and reinserted into the support tray 140 to suit the user's comfort, as will be explained in greater detail below.

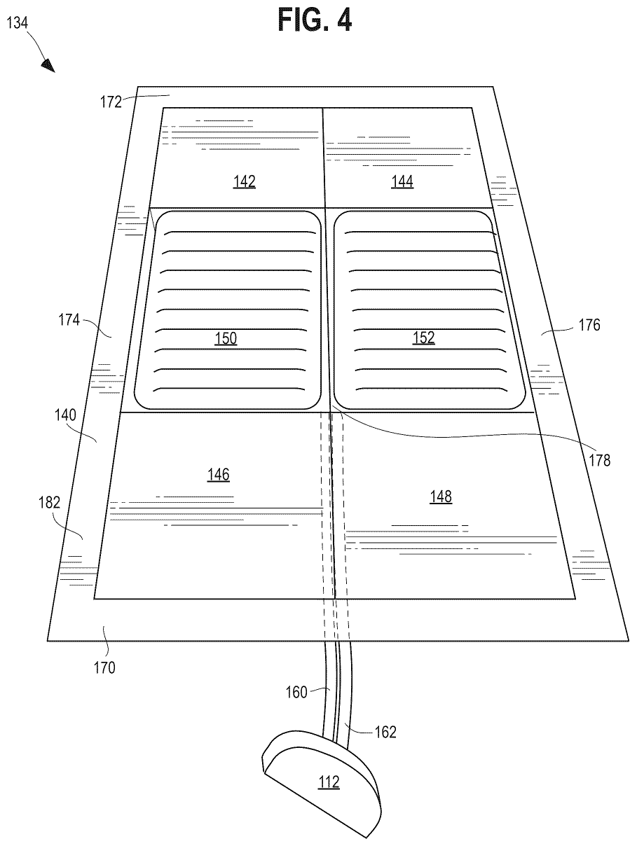

Turning to FIG. 4, the first tube 160 and the second tube 162 (shown partially in phantom) connect to first inflatable air chamber 150 and the second inflatable air chamber 152, respectively. The first tube 160 runs from the pump 112 between the third support block 146 and the bottom wall 178. Similarly, the second tube 162 runs from the pump 112 between the fourth support block 148 and the bottom wall 178.

While the foregoing description refers to first 150 and second 152 inflatable air chambers, it is contemplated within the scope of the present disclosure for an embodiment incorporating a single inflatable air chamber in place of separate first and second air chambers. In such embodiments, the tubing 122 for the pump 112 may include a single tube supplying the single inflatable air chamber with air. Such embodiments may be suitable for smaller mattresses, such as a twin mattress, that would typically to be used by a single person. The operation of such embodiments would not significantly change from what is otherwise described in this disclosure. Similarly, in such embodiments, it may be beneficial to incorporate single support blocks at the foot and head regions of the mattress.

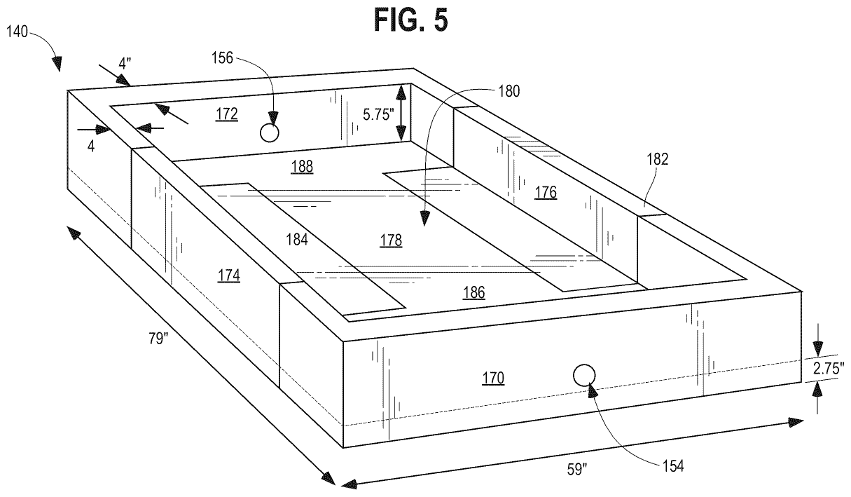

Referring to FIG. 5, the second sidewall 172 defines the second passage 156. In some embodiments, the pump 112 (shown in FIG. 4) is placed proximate to the second sidewall 172 and the tubing 122 (shown in FIG. 4) extends from the pump 112 through the second passage 156 into the cavity 180. While the support tray 140 may have any dimensions, in some embodiments, the support tray 140 is generally sized to correspond with standard mattress footprints (e.g., full, queen, king, etc.).

Remaining with FIG. 5, the bottom wall 178 includes a lumbar region 184 connected to a head region 186 and a foot region 188. The lumbar region 184, the head region 186, and the foot region 188 are formed of elastomeric foam. In some embodiments, the lumbar region 184 is firmer than the head region 186 and the foot region 188 to provided increased support to the lumbar region of the user.

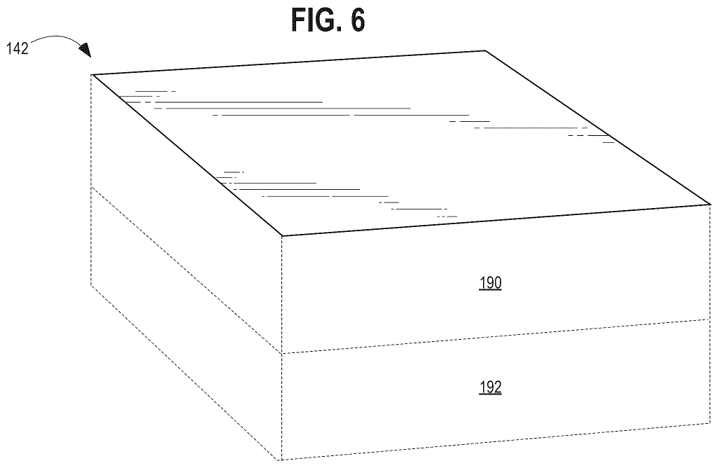

Looking to FIG. 6, the first support block 142 includes a first layer 190 attached (e.g., glued, heat bonded, fastened, etc.) to a second layer 192. In some embodiments, the first layer 190 and the second layer 192 are formed of elastomeric foam. In some embodiments the first layer 190 and the second layer 192 are form of elastomeric foams of differing densities. Thus, in some embodiments, the first layer 190 is firmer than the second layer 192.

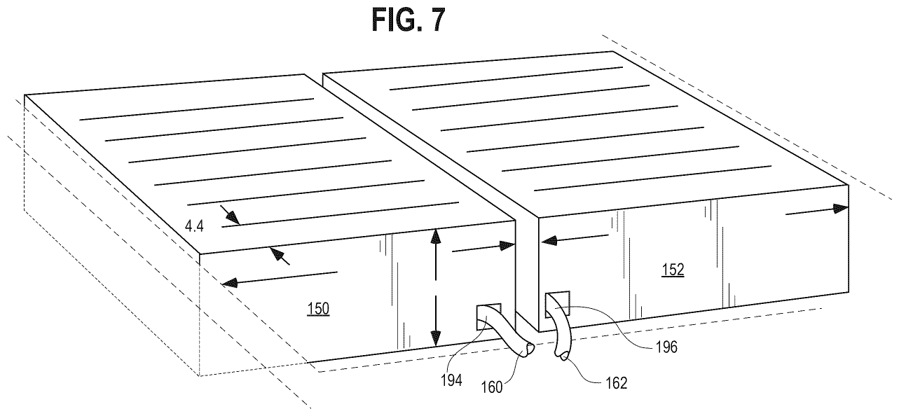

Referring to FIG. 7, the first inflatable air chamber 150 and the second inflatable air chamber 152 have a first port 194 and a second port 196, respectively. The first tube 160 connects to the first inflatable air chamber 150 via the first port 194. Similarly, the second tube 162 connects to the second inflatable air chamber 152 via the second port 196.

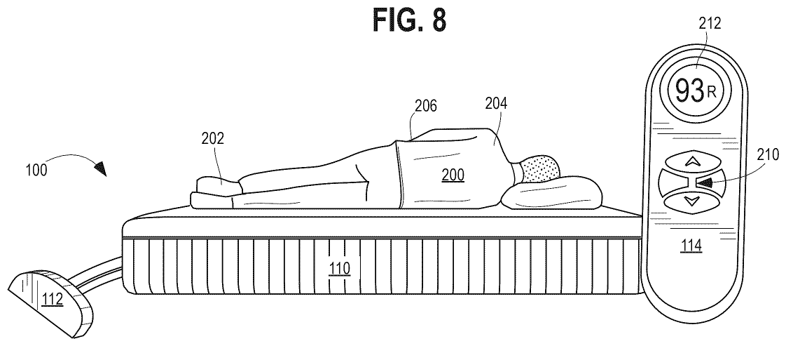

Referring to FIG. 8, in operation, a user 200 rests by lying on the adjustable mattress 110 of the first variable firmness sleep system 100. Before lying down, the user 200 arranges and orient (e.g., flips) the first support block 142, the second support block 144, the third support block 146, and the fourth support block 148 to suit the comfort of the user 200. For example, the user 200 may orient the first support block 142, the second support block 144, the third support block 146, the fourth support block 148 (shown in FIG. 3) to have the firmer density first layer 190 (shown in FIG. 6) facing upwardly at the user's feet 202 and the softer density second layer 192 (shown in FIG. 6) facing upwardly at the user's shoulders 204.

Referring to FIG. 8, further in operation, the user 200 controls the pump 112 via the remote control 114 to adjust the internal air pressures of the first inflatable air chamber 150 and the second inflatable air chamber 152 (shown in FIG. 3) to adjust the level of support and/or firmness at the user's lumber region 206 according to the user's 200 comfort. The remote control 114 has a plurality of buttons 210 and a display 212. The user 200 selectively presses individual buttons of the plurality of buttons 210 to control the pump 112. In some embodiments, using the plurality of buttons 210, the user 200 may command the pump 112 to inflate, deflate, and toggle between the first inflatable air chamber 150 and the second inflatable air chamber 152. In some embodiments, using the plurality of buttons 210, the user 200 may command the pump 112 to adjust internal air pressures of the first inflatable air chamber 150 and/or the second inflatable air chamber 152 to a predetermined saved value. The display 212 shows the commanded internal air pressures of the first inflatable air chamber 150 and the second inflatable air chamber 152.

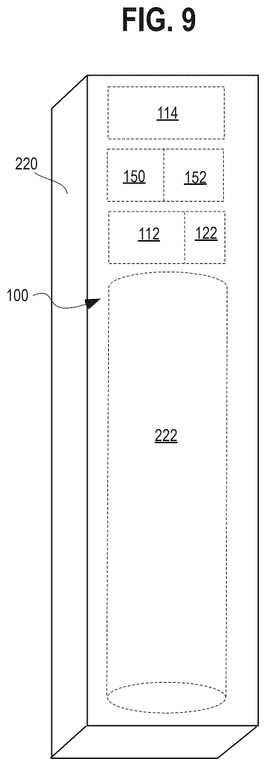

Referring to FIG. 9, in some embodiments, the first variable firmness sleep system 100 can be disassembled and packed into a shipping box 220. Resilient components 222 of the adjustable mattress 110 include the upper pad 132, the support tray 140, the first support block 142, the second support block 144, the third support block 146, and the fourth support block 148. These resilient components 222 may be compressed and rolled cylindrically to fit in the shipping box 220. Further, the pump 112, the remote control 114, the tubing 122, the first inflatable air chamber 150, and the second inflatable air chamber 152 may be placed in the shipping box 220.

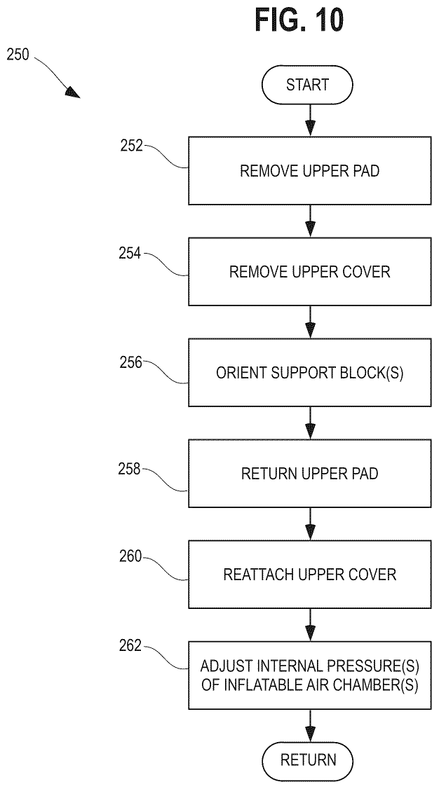

FIG. 10 illustrates a first method 250 for operating the first variable firmness sleep system 100 of FIG. 1. The first method 250 starts at block 252, where the upper cover 116 is removed (e.g., unzipped) from the lower cover 118. The first method 250 proceeds to block 254.

At block 254, the upper pad 132 is removed from the base 134. The first method 250 proceeds to block 256.

At block 256, one or more of the first support block 142, the second support block 144, the third support block 146, and the fourth support block 148 is reoriented (e.g., flipped) to face a desired one of the first layer 190 and second layer 192 upwardly according to a user's 200 comfort. The first method 250 proceeds to block 258.

At block 258, the upper pad 132 is returned to the base 134. The first method 250 proceeds to block 260.

At block 260, the upper cover 116 is reattached (e.g., zipped) to the lower cover 118. The first method 250 proceeds to block 262.

At block 262, using the remote control 114 and the pump 112, one or more internal air pressures of the first inflatable air chamber 150 and the second inflatable air chamber 152 are adjusted to suit a user's 200 comfort. The first method 250 then returns to block 252.

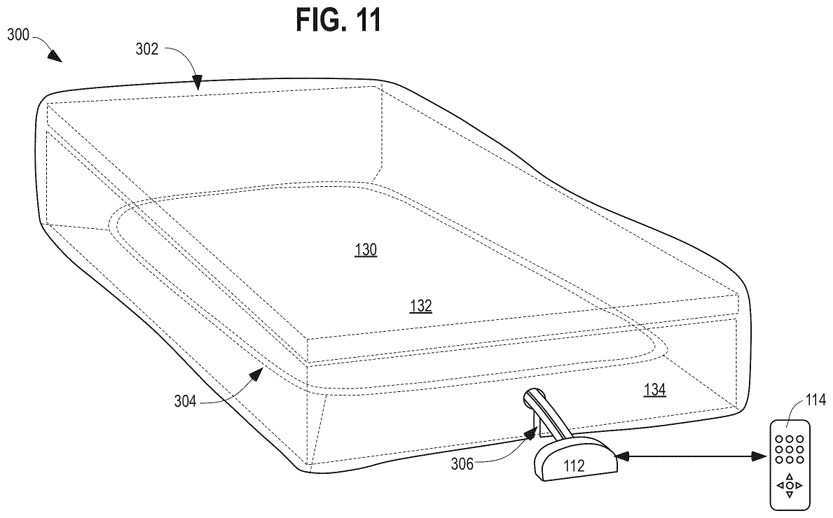

Referring to FIG. 11, a second variable firmness sleep system 300 includes the pump 112, the remote control 114, the tubing 122, the cushion assembly 130 (shown in phantom), and a slipcover 302. The pump 112 communicates with the remote control 114 as described above. The tubing 122 connects the pump 112 to the cushion assembly 130 as described above. The slipcover 302 includes an elastic band 304 to snugly envelop the cushion assembly 130. Further, the slipcover 302 defines a cutout 306 to accommodate the tubing 122.

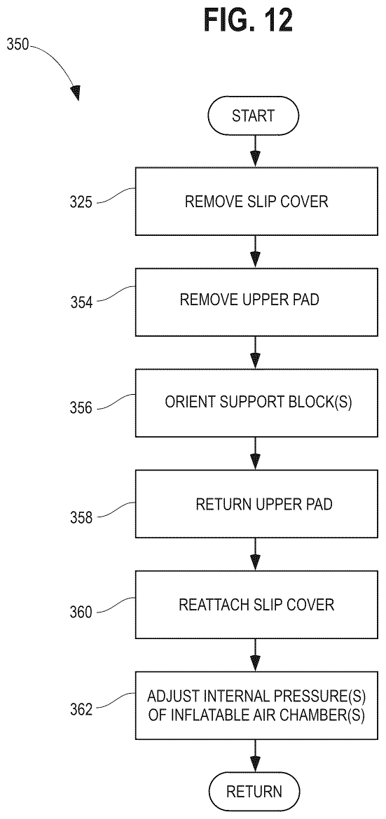

FIG. 12 illustrates a second method 350 for operating the second variable firmness sleep system 300 of FIG. 11. The second method 350 starts at block 352, where the slipcover 302 is removed from the cushion assembly 130. The second method 350 proceeds to block 354.

At block 354, the upper pad 132 is removed from the base 134. The second method 350 proceeds to block 356.

At block 356, one or more of the first support block 142, the second support block 144, the third support block 146, and the fourth support block 148 is reoriented (e.g., flipped) to face a desired one of the first layer 190 and second layer 192 upwardly according to a user's 200 comfort. The second method 350 proceeds to block 358.

At block 358, the upper pad 132 is returned to the base 134. The second method 350 proceeds to block 360.

At block 360, the slipcover 302 is reattached to the cushion assembly 130. The second method 350 proceeds to block 362.

At block 362, using the remote control 114 and the pump 112, one or more internal air pressures of the first inflatable air chamber 150 and the second inflatable air chamber 152 are adjusted to suit a user's 200 comfort. The second method 350 then returns to block 352.

In other embodiments, other configurations are possible. For example, those of skill in the art will recognize, according to the principles and concepts disclosed herein, that various combinations, sub-combinations, and substitutions of the components discussed above can provide appropriate cooling for a variety of different configurations of motors, pumps, electronic assemblies, and so on, under a variety of operating conditions.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

What is claimed is:

1. An adjustable mattress assembly comprising:
a support tray;
an inflatable air chamber removably disposed in the support tray;
a support block removably and reorientably disposed in the support tray, the support block including
a first layer formed of a first foam, and
a second layer bonded to the first layer, the second layer being formed of a second foam, the first foam being firmer than the second foam; and
an upper pad removably overlaying the support tray, the inflatable air chamber, and the support block.

2. The adjustable mattress assembly of claim 1, wherein the support block is flippable to selectively face the first layer or the second layer upwardly.

3. The adjustable mattress assembly of claim 1, wherein the inflatable air chamber is configured to be selectively inflated and deflated.

4. The adjustable mattress assembly of claim 1, wherein the support tray is formed of a third foam and the upper pad is formed of a fourth foam.

5. The adjustable mattress assembly of claim 1, wherein the support block is a first support block and further comprising a second support block, the second support block being identical to the first support block, the inflatable air chamber being between the first support block and the second support block, and the upper pad removably overlaying the second support block.

6. The adjustable mattress assembly of claim 1, wherein the inflatable air chamber and the support block fit together snugly to substantially prevent movement of the inflatable air chamber and the support block relative to one another.

7. The adjustable mattress assembly of claim 1, wherein the inflatable air chamber fits in the support tray snugly to substantially prevent movement of the inflatable air chamber relative to the support tray.

8. The adjustable mattress assembly of claim 1, wherein the support block fits in the support tray snugly to substantially prevent movement of the support block relative to the support tray.

9. The adjustable mattress assembly of claim 1, further comprising an upper cover removably attached to lower cover, the upper cover and the lower cover enveloping the support tray and the upper pad.

10. The adjustable mattress assembly of claim 1, further comprising a slipcover enveloping the upper pad and secured to the support tray.

11. A variable firmness sleep system comprising:
a remote control;
a pump in communication with the remote control; and
an adjustable mattress assembly connected to the pump, the adjustable mattress assembly including
a support tray,
an inflatable air chamber removably disposed in the support tray and in fluid communication with the pump, and
a support block removably and reorientably disposed in the support tray, the support block including
a first layer formed of a first foam, and
a second layer bonded to the first layer, the second layer being formed of a second foam, the first foam being firmer than the second foam.

12. The variable firmness sleep system of claim 11, wherein the remote control selectively instructs the pump to adjust an internal air pressure of the inflatable air chamber.

13. The variable firmness sleep system of claim 12, wherein the pump selectively inflates and deflates the inflatable air chamber.

14. The variable firmness sleep system of claim 12, wherein the pump adjusts the internal air pressure of the inflatable air chamber to a predetermined value.

15. The variable firmness sleep system of claim 11, wherein the inflatable air chamber and the support block are disposed within the support tray.

16. The variable firmness sleep system of claim 11, wherein the support tray defines a passage, the inflatable air chamber is connected to the pump via tubing, and the tubing extends through the passage.

17. The variable firmness sleep system of claim 11, wherein the support block is a first support block and further comprising a second support block, the inflatable air chamber being between the first support block and the second support block.

18. The variable firmness sleep system of claim 11, wherein the inflatable air chamber is a first inflatable air chamber and further comprising a second inflatable air chamber in fluid communication with the pump, the first inflatable air chamber abutting the second inflatable air chamber.

19. The variable firmness sleep system of claim 18, wherein the remote control selectively instructs the pump to toggle between the first inflatable air chamber and the second inflatable air chamber.

20. A method for customizing an adjustable mattress comprising:
removing an upper cover of the adjustable mattress from a lower cover of the adjustable mattress;
removing an upper pad of the adjustable mattress from a base of the adjustable mattress;
orienting one or more support blocks of the base, each of the one or more support blocks including
a first layer formed of a first foam, and
a second layer bonded to the first layer, the second layer being formed of a second foam, the first foam being firmer than the second foam;
returning the upper pad to the base;
reattaching the upper cover to the lower cover; and
adjusting, with a pump, internal pressures of one or more inflatable air chambers of the base.
